(19) United States
(12) Patent Application Publication
(10) Pub. No.: US 2020/0334557 A1
(43) Pub. Date: Oct. 22, 2020

(54) CHAINED INFLUENCE SCORES FOR IMPROVING SYNTHETIC DATA GENERATION

(71) Applicant: CHATTERBOX LABS LIMITED, Greater London (GB)

(72) Inventors: Gülce Kale, Greater London (GB); Stuart Battersby, Greater London (GB); Zheng Yuan, Greater London (GB); Niall McCarroll, Greater London (GB); Danny Coleman, Greater London (GB)

(21) Appl. No.: 16/387,810

(22) Filed: Apr. 18, 2019

(51) Int. Cl. G06N 5/04; G06N 20/00

(52) U.S. Cl. CPC G06N 5/048; G06N 20/00

(57) ABSTRACT

The embodiments described herein combine a number of mathematical techniques to address the problem of efficiently assessing the quality of predictions by machine learning models or explaining said predictions to a user. Influence functions are used to estimate the influence of training data points on a particular prediction made by a model in order to help explain why that prediction was justified. Through the use of influence functions, repeated retraining of the model is avoided, thereby providing a more computationally efficient means of assessing the quality of the predictions. In addition, a novel quality metric is proposed for effectively quantifying the quality of a particular prediction.

### TECHNICAL FIELD

The present disclosure relates to improvements in the computational efficiency and accuracy of determining the influence of a training data point on a machine learning model and of determining one or more quality metrics quantifying the quality of a set of one or more predictions by a machine learning model. In particular, but without limitation, this disclosure relates to improvements in the computational efficiency and accuracy of determining statistical measures of quality of machine learning predictions, particularly for predictions based on a chain of machine learning models.

### BACKGROUND

Synthetic data generation methods aim to generate new (synthetic) data points that have one or more attributes that are similar to an original (observed) data set. The synthetic data points are new data points, in that they do not match any of the original observed data points.

Synthetic data generation can be achieved through the identification of statistical trend(s) in the observed data. By constructing a statistical model of the data, additional data points can be generated that reflect the identified trend(s) but do not exactly match any of the original data points.

Data synthesis is useful as it allows larger data sets to be built from small sets of observed data, e.g., for use in data analysis or machine learning. Machine learning methods often require large training data sets. By generating new synthetic data that shares the properties of the original data, this new data can be used to build a larger training data set to generate a more accurate machine learning model.

Furthermore, synthetic data generation is important for data security and privacy. As synthetic data does not include any of the original data points, the synthetic data can be shared (e.g. for analysis or machine learning) even if the original data points cannot be shared for confidentiality or privacy reasons.

There are many available techniques for synthesizing data points from a set of real “observed” data by finding patterns in the original data and exploiting the patterns to generate new data points that conform to these patterns. Having said this, many synthetic data generation methods can be difficult to understand for users that are not necessarily experts in synthetic generation. In this case, the synthetic data generator can appear as a “black box”, and the user may be unsure as to the quality of the generated data.

Furthermore, the complexity of some models means that it can be difficult to determine a quality metric associated with synthetic data. Some quality metrics require repeated retraining of the models, which can be very computationally expensive. There is therefore a need to be able to easily and efficiently assess the quality of synthetic data without requiring repeated retraining of the models.

### SUMMARY

The embodiments described herein combine a number of mathematical techniques to address the problem of efficiently assessing the quality of predictions by machine learning models or explaining said predictions to a user.

Influence functions are used to estimate the influence of training data points on a particular prediction made by a model in order to help explain why that prediction was justified. Through the use of influence functions, repeated retraining of the model is avoided, thereby providing a more computationally efficient means of assessing the quality of the predictions. In addition, a novel quality metric is proposed for effectively quantifying the quality of a particular prediction.

The methods described herein make use of influence functions. An influence function, in the context of a machine learning prediction (such as a synthetically generated data point), provides a measure of the dependence of the prediction on a particular value within the original data set. Influence functions can be difficult to calculate, particularly for data generated from a chain or sequence of machine models, such as Sequential Regression Multivariate Imputation (SRMI).

Influence functions can be calculated using the derivative of the loss function for the model; however, where chains of machine-learning models are used, there is no single loss function for calculating the influence of a data point. The embodiments overcome this technical problem to provide an efficient and effective means of calculating the influence of a data point on a predicted data point. This influence value can then be used to quantify the quality of the predicted data point.

According to a first aspect there is provided a computer-implemented method for determining an influence of a training data point on a prediction generated according to a machine learning model. The method comprises: (a) obtaining the training data point, the training data point having an observed value for each of a plurality of features; (b) obtaining the prediction, the prediction having a predicted value for each of the plurality of features generated according to the machine learning model, the machine learning model comprising a plurality of submodels, wherein each submodel is configured to generate a corresponding predicted value for a corresponding feature of the plurality of features; (c) for each feature, calculating an influence score representing the influence of the training data point on the prediction of the corresponding predicted value for the feature by the corresponding submodel; and (d) calculating a combined influence score representing the influence of training data point on the prediction by multiplying together the influence scores for the training data point.

Accordingly, the embodiments described herein are able to calculate a combined influence score for a machine learning model comprising a plurality of submodels without requiring the machine learning model to be retrained. The embodiments therefore provide improvements in computational efficiency relative to alternative methods.

The machine learning model may have been trained at least in part based on the training data point. The combined influence score is therefore indicative of the influence of the training data point on the predication in light of the training of the machine learning model. The method may further comprise obtaining the machine learning model by training the machine learning model based at least on the training data point. The method may comprise calculating the prediction implementing the machine learning model.

The prediction may be the generation of a synthetic data point or may be any other form of prediction. For synthetic data generation, the machine learning model may be a Sequential Regression Multivariate Imputation (SRMI) model.

The training data point may be an observed data point, in that the training data point includes one or more observable variables. The training data point may alternatively include one or more latent variables.

According to an embodiment the influence score for each submodel is based on an influence function conditioned on a loss function for the corresponding submodel and a Hessian matrix of the corresponding submodel. Each submodel might be twice differentiable. This allows each influence score to be calculated without requiring each submodel to be retrained.

According to an embodiment one or more of the submodels are conditioned on one or more of the predicted values. That is, the machine learning model may be formed from a chain or sequence of submodels, where one or more of the submodels are conditioned on one or more predicted values calculated from one or more corresponding other submodels.

According to a further embodiment the influence function is:

influence(xᵢ^{train},M,xⱼ^{test})=−∇ [symbol] (xⱼ^{test},M)=^{T}·H⁻¹·∇ [symbol] (xᵢ^{train},M)
where:
   x^{traim} is the training data point;
   x^{test} is the predicted value determined by submodel M;
   ∇ [symbol] (x, M) is the gradient of the loss function of submodel M with respect to parameters of the submodel M and evaluated at data point x; and
   H is the Hessian matrix of submodel M.

According to a further embodiment the training data point is obtained as part of a plurality of training data points that are obtained and the method further comprises repeating step (c) to determine influence scores for one or more further training data points from the plurality of training data points, wherein each of the influence scores is normalized across the plurality of training data points.

Normalizing the influence scores across a plurality of training data points ensures more accurate combined influence score (as the normalized influence score represents the relative influence across the training data set). Each training data point may include the same plurality of features.

According to an embodiment the method comprises outputting the combined influence score. This allows a user to determine the influence of the training data point on the prediction, or allows a computing system to make use of the combined influence score.

According to a further embodiment the training data point is obtained as part of a plurality of training data points that are obtained and the method further comprises: (e) repeating steps (c)-(d) to determine a corresponding combined influence score for each of the plurality of training data points to form a set of combined influence scores for the prediction.

According to a further embodiment the method further comprises: (g) determining a quality metric for the prediction, including: for each of the plurality of training data points, determining a corresponding similarly between the training data point and the prediction in accordance with a similarity metric; identifying a closest training data point that is the most similar to the prediction in accordance with the similarity metric; ranking the plurality of training data points in order of combined influence scores to determine a rank for the closest training data point; and calculating the quality metric for the prediction based on a reciprocal of the rank of the closest training data point.

Accordingly, a quality metric for the quality of the prediction can be determined based on the combined influence scores. This provides a simple, quantitative measure of the quality of the prediction that can be used, for instance, to determine whether the model requires adapting and/or whether the prediction can be relied upon.

According to a further embodiment the prediction is obtained as part of a plurality of predictions that is obtained, and the method further comprises: repeating step (f) to determine a corresponding set of combined influence scores for each of the plurality of predictions; repeating step (g) to determine a quality metric for each of the plurality of predictions; and determining a combined quality metric for the plurality of predictions based on a mean of the quality metrics for the plurality of predictions.

Obtaining a combined quality metric indicates the quality across a plurality of predictions. This allows a computing system and/or the user to determine whether to update the model and/or to rely on the predictions.

According to a further embodiment the method further comprises one or more of: outputting the combined quality metric; and updating parameters of the machine learning model in response to the combined quality metric being below a predefined threshold.

Updating parameters of the machine learning model might comprise retraining the model based one or both of: additional training data points; and a subset of the training data points.

According to a second aspect there is provided a computer-implemented method for determining one or more quality metrics quantifying the quality of a set of one or more predictions by a machine learning model. The method comprises determining a quality metric for each of a set of one or more predictions, including, for each of the set of one or more predictions: obtaining, for each of a plurality of training data points, an influence score representing the influence of the training data point on the prediction by the machine learning model; for each of the plurality of training data points, determining a corresponding similarly between the training data point and the prediction in accordance with a similarity metric; identifying a closest training data point that is the most similar to the prediction in accordance with the similarity metric; ranking the plurality of training data points in order of influence scores to determine a rank for the closest training data point; and calculating the quality metric for the prediction based on a reciprocal of the rank of the closest training data point.

Embodiments are therefore able to quantify the quality of one or more predictions based on the influence scores for those predictions. These influence scores may be calculated through any method. The prediction may be any type of prediction, including a prediction of synthetic data.

The method may further comprise generating the set of one or more predictions using the machine learning model. The method may comprise training the machine learning model based at least on the plurality of training data points.

According to a further embodiment the method further comprises outputting the quality metric for each of the set of one or more predictions.

According to a further embodiment: the set of one or more predictions comprises a plurality of predictions; and the method further comprises determining a combined quality metric for the plurality of predictions based on the mean of the quality metrics for the plurality of predictions.

According to a further embodiment the method further comprises outputting the combined quality metric.

According to a further embodiment the similarity metric is a distance metric. Any appropriate distance metric may be used, such as Euclidian distance.

According to a further embodiment: each training data point has an observed value for each of a plurality of features; each prediction has a predicted value for each of the plurality of features generated according to the machine learning model, wherein the machine learning model comprises a plurality of submodels, wherein each submodel is configured to generate a corresponding predicted value for a corresponding feature of the plurality of features; and obtaining, for each of a plurality of training data points, an influence score representing the influence of the training data point on the prediction by the machine learning model comprises: for each feature, calculating a submodel influence score representing the influence of the training data point on the prediction of the corresponding predicted value for the feature by the corresponding submodel; and calculating the influence score representing the influence of training data point on the prediction by multiplying together the submodel influence scores for the training data point.

Accordingly, the quality metric may be determined based on influence scores calculated for a machine learning model having a plurality of submodels.

According to a further aspect there is provided a computer-implemented method for determining a quality metric quantifying the quality of a set of one or more synthetic data points generated by a machine learning model. The method comprises: obtaining a set of training data points and a set of one or more synthetic data points generated based on a machine learning model that has been trained using the set of training data points; determining a set of one or more mean distances; and outputting a quality metric based on the set of one or more mean distances. The set of one or more mean distances are be determined by, for each of the set of one or more synthetic data points: identifying the k closest training data points to the synthetic data point from the set of training data points based on a distance metric, wherein k is a predefined number; and determining the mean distance from the synthetic data point to the k closest training data points.

A quality metric may therefore be based on one or more mean distances one or more synthetic data points and k closest training data points. In one embodiment, a quality metric is determined for each synthetic data point, wherein the quality metric is equal to the mean distance for that synthetic data point. In an alternative embodiment, the quality metric is indicative of the quality of a plurality of synthetic data points, and the quality metric is obtained based on the mean distances for the plurality of synthetic data points.

The method may further comprise generating the one or more synthetic data points using the machine learning model. The method may comprise training the machine learning model based on the training data points.

According to an embodiment the set of one or more synthetic data points comprises a plurality of synthetic data points and the method further comprises determining the quality metric as an indicator of the quality of the plurality of synthetic data points including determining the fraction of the plurality of synthetic data points that have a mean distance that falls within a range.

According to an embodiment the method further comprises determining a further set of mean distances and determining the range based on the further set of mean distances. The further set of mean distances are determined by, for each training data point: identifying the k closest training data points to the training data point based on the distance metric; and determining the mean distance from the training data point to the k closest training data points.

According to an embodiment determining the range comprises determining an upper threshold for the range, wherein a first predefined proportion of the training data points have mean distances that are less than the upper threshold.

According to a further embodiment determining the range comprises determining a lower threshold for the range, wherein a second predefined proportion of the training data points have mean distances that are less than the upper threshold, the second predefined proportion being smaller than the first predefined portion.

According to a further embodiment there is provided a computing system comprising one or more processors configured to perform any of the methods described herein.

According to a further embodiment there is provided a non-transitory computer readable medium comprising instructions that, when executed by one or more processors, cause the one or more processors to perform any of the methods described herein.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a method for generating a synthetic data point;

FIG. 2 shows a method of determining a combined influence score of an observed data point on the generation of a synthetic data point according to an embodiment;

FIG. 3 shows a method of determining a quality metric based on influence scores according to an embodiment.

FIG. 4 shows the method of determining the synthetic quality metric SYNTHQ given a set of observed data points and a set of synthetic data points that are synthesized from the observed data points; and

FIG. 5 shows a computing system for performing the methods described herein.

### DETAILED DESCRIPTION

The approach described herein provides a novel means of determining the quality of a synthetically generated data point. The methods described herein help to explain how synthetic data points are obtained from an original dataset containing real observed data points. The objective is to help explain the quality and overall usefulness of synthesized data values and points by linking them to the observed data points that contributed the most to the likelihood of the synthesis of those values.

The approach is designed to work with the Sequential Regression Multivariate Imputation (SRMI) data synthesis method, which can synthesize numeric, text and categorical data. Having said this, the methods described herein are applicable to any machine learning methods that include a chain or sequence of machine learning models.

The embodiments described herein utilize an approach called influence functions to obtain ranked lists of observed data points that most influenced the generation of each value in the synthetic data point. A list is constructed that represents the influence of the observed (training) data points on the entire data point (by chaining). This provides a simple and efficient method for determining which observed data points provided the greatest influence over the generation of individual generated data points. This provides a simple means for the user to ascertain the type and validity of the data point that has been generated.

It has not previously been possible to obtain influence values efficiently for chains of machine learning models. Some methods require the chain of models to be retrained each time an influence value is calculated. This can result in a very large number of calculations. The methods described herein are able to obtain influence values for chains of machine learning models without requiring such retraining; thereby producing a more efficient means of obtaining influence values.

A further process is proposed to establish a quality metric of the generation process by comparing the observed and synthetic data points using distance functions. This allows a user to ascertain easily how accurately the synthetic data represents the original dataset without simply being a copy of it.

The results delivered by the methods described herein can be utilized in the following ways:
(1) They provide a subject matter expert with a faster way to understand their synthetic data set by showing them the observed data points that contributed to the generation of particular synthetic data points.
(2) They drive the improvement in the quality of the synthesized data—the proposed quality metric allows the parameters of the SRMI (or other data synthesis algorithm) to be fine-tuned
(3) They drive the improvement in the quality of the synthesized data with respect to intended use case(s) for the synthetic data by identifying observed data points which influenced the generation of synthetic data points which an expert considers anomalous or inappropriate. These observed points may then be removed and the synthetic data re-generated.

### Synthetic Data Generation

Synthetic data generation often makes use of machine learning methods. These are generally based on obtaining feature vectors for the sets of real and observed data points. For each data point, its corresponding feature vector describes the data point using an array of real numbers. Each feature represents be an observed attribute of the data. Feature vectors can be obtained from data points containing any kind of data values including numeric data, categorical data, text, images, audio and video.

To provide context, a simple example is provided where the feature vector is obtained directly from the numeric values in the input data. The observed data consists of the measurements of 1000 flower specimens consisting of four columns per flower. Each observed row is assigned a row-identifier i.

| i | Sepal-length | Sepal-width | Petal-length | Petal-width |
|---|---|---|---|---|
| 1 | 3.2 | 2.9 | 8.1 | 8.7 |
| 2 | 6.4 | 6.2 | 3.2 | 5.1 |
| . . . | . . . | . . . | . . . | . . . |
| 1000 | 4.1 | 4.9 | 6.1 | 6.7 |

The feature vector for each data point comprises the set of features for that data point. This is the row for that data point. For instance, the feature vector for the first row contains the values [3.2, 2.9, 8.1, 8.7].

### Sequential Regression Multivariate Imputation (SRMI)

Sequential Regression Multivariate Imputation (SRMI) is a type of synthetic data generation model. SRMI is able to generate new data based on the relationships between features in the data.

Specifically, SRMI includes a number of imputation steps in which a particular feature is generated based on another feature. The next feature is then generated based on the previously generated feature. For instance, in the example above, a value of sepal width may be generated based on an initialized value of sepal length. The petal length can then be generated based on the sepal width and sepal length. Finally, the petal width can be generated based on the generated sepal width, sepal length and petal width.

The SRMI model for this dataset is therefore constructed from a series of predictive models fitted to the feature vectors extracted from the observed data. In the present example, three new values are generated (sepal width, petal length and petal width). The SRMI model therefore comprises three predicted models: M₁, M₂, M₃.

Each model (M₁, M₂, M₃) within the SRMI model sequence predicts a column given values for one or more predictor columns:

| Model | Predictors | Predicts |
|---|---|---|
| M₁ | [Sepal-length] | Sepal-width |
| M₂ | [Sepal-length, Sepal-width] | Petal-length |
| M₃ | [Sepal-length, Sepal-width, | Petal-width |
| | Petal-length] | |

The observed dataset acts as training data for these models. Synthetic values of the first column, Sepal-length, are obtained from a random sample of the observed values for Sepal-length. Models M₁, M₂ and M₃ are regression models trained on (fitted to) the observed dataset and introduce some random noise in the predictions they output.

To create a complete, new data point (or row), each model is implemented sequentially. As each model outputs a new column value, this value is subsequently used as input for the next model. Therefore, each complete row of data is constructed by applying models that generated a column value sequentially.

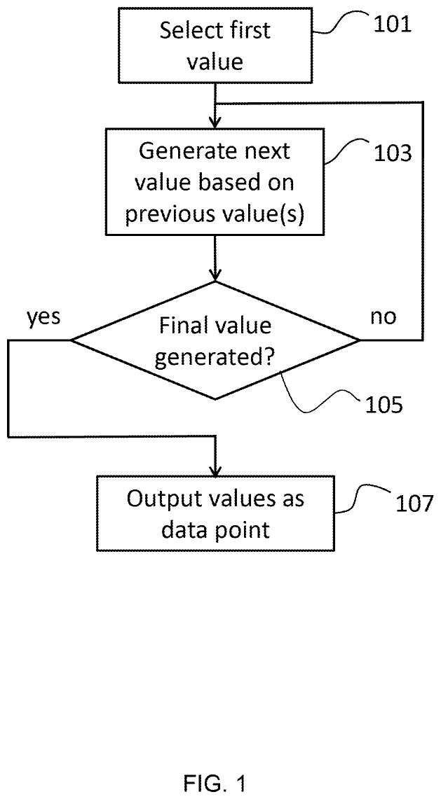

FIG. 1 shows a method for generating a synthetic data point.

The method begins be selecting a first value for the first attribute that is to be determined 101. The first value may be a selection of a value for the first attribute taken from a random selection from the set of observed values.

The method then generates the next value for the next attribute based on the previous value (in this case, the previous value is the first value) 103. The next value is generated using a machine learning model that predicts a value for the next attribute based on the previous attribute. The machine learning model is trained using the observed data points.

The method then determines whether the final value (the final attribute) for the data point has been generated 105. If not, then the method loops back to step 103 to generate the next value for the next attribute based on one or more of the previous values. Generally, each of the previous values is used to form the next value; however, a subset of the previous values may be taken. Each time a different attribute is predicted, a different machine learning model is used.

If the final value for the final attribute has been generated then the values are output as a (synthesized) data point 107. The method may then be repeated to generate a further synthesized data point.

In light of the above, the generation of a data point involves a set of sequential predictions. Given the sequential nature of the predictions, it can be difficult to determine the influence on a particular data point from the original data. This is because the final attribute predicted by the model is not only based on the trained data (via the model for that prediction step) but also on the attributes generated for that data point.

Whilst the embodiments described herein are applied to SRMI, the general teaching of these embodiments can also be applied to any SRMI-like data synthesis approach having multiple predictive models, or even a machine learning approach for a different function other than data synthesis, provided the approach includes a set of constituent models that each has a loss function that is twice-differentiable. For example, some classes of Neural Network model have this mathematical property and so could be employed instead of the linear models adopted by SRMI.

### Influence Functions

Generally, data synthesis generates a data point x from a model M that is based on a training data set {xᵢ^{train}}ᵢ₌₁^{N}^{ₒ} of Nₒ observed data points. This produces a set {xᵢ^{synth}}iᵢ₌₁^{N}^{ₛ} of Nₛ synthesized data points

Machine learning models are based on observed data, as they are models having parameters that have been fit to the observed data based on a number of training steps. These training steps generally include a loss function [symbol] (x, M), which is used in parameter update steps to update the parameters of the model.

Influence functions allow the computation of the influence of a particular training data point on the prediction of a particular value. An observed (training) data point is influential (has a high influence value) when the deletion of that observed data point from the observed set of data points produces a large change in the parameters or predictions of the model that is trained on the observed set. The influence can be determined either through deletion of the data point and retraining the model; however, retraining the model for each data point can be computationally expensive.

The influence function provides an alternative to the above method and allows the calculation of the influence of a data point without requiring retraining, provided that the model is twice differentiable. The influence function works through the application of a weighting to the data point by approximating parameter changes to the model based on the gradients of the model parameters.

The influence function for a particular training data point xₜᵣₐᵢₙ on the prediction of a particular value (a particular test point) xⱼ^{test} is:

influence(xᵢ^{train},M,xⱼ^{test})=−∇ [symbol] (xⱼ^{test},M)=^{T}·H⁻¹·∇ [symbol] (xᵢ^{train},M)

where ∇ [symbol] (x, M) is the gradient of the loss function of model M on data point x and H is the Hessian matrix of model M. Specifically, ∇ [symbol] (x, M) is the gradient of the loss function with respect to the model parameters evaluated at the data point x. Accordingly, the influence function is applicable to any machine learning model that has an associated gradient of a loss function with respect to the model parameters.

Examples of such models include logistic regression, neural networks and support vector machines.

The influence function returns values in the range −∞ to +∞. Values close to zero indicate that the training point has low influence on the predicted value.

Identifying influential data points can help users to debug or further improve the machine learning model. For instance, if a data synthesis model is generating data that appears to be erroneous (or at least anomalous), identifying the influential observed data points for this erroneous data can help a user to assess whether the data is indeed erroneous (e.g. through comparison to the influential observed data points).

For example, if the synthetic data is similar to its most influential observed data points, then this suggests that the synthetic data is accurate (i.e. not erroneous or anomalous). Conversely, if the data is not similar to the most influential data points, then it is likely erroneous.

Furthermore, identification of influential data points can help improve the accuracy of a data synthesis model. For instance, if a number of observed data points have a large influence on the generation of a number of undesired synthetic data points (for instance, data points that appear erroneous or anomalous) and low influence on desirable synthetic data points (e.g. non-anomalous data points), then the deletion of these observed data points from the training set can help to improve the accuracy of the data generation model. Alternatively, if erroneous synthetic data points are highly influenced by a small subset of observed data points that are not well represented within the observed data set, then obtaining more observed data points in this group can help to train the system to more accurately generate synthetic data in this category of data points.

An example of this would be a synthetic data generator that generates pictures of animals. If it is unable to generate pictures of brown dogs well, this might be an indicator that the observed data set does not have a sufficiently large number of pictures of dogs. Having said this, the model may equally be failing due to a lack of pictures of brown animals. Identifying the most influential training data points can help determine how best to improve the training data set to produce a more effective generative model.

Having, said this, it is not currently known how to apply influence functions to chains of statistical models (such as SRMI). This can be difficult, as each subsequent model is conditioned at least partly on the previous model(s) in the chain. The influence function shown above relies on the derivative of the loss function of the model. If a machine learning method relies on a sequence of models, then there will be no single loss function for the overall method.

Without an effective means of determining influence functions for sequences of models, users would need to adopt the more computationally expensive approach of retraining the system multiple times, once for the removal of each observed data point, in order to determine the influence of the observed data points on the synthetic data. In a system with Nₘ chained models for predicting synthesized data points from Nₒ observed data points, this would result in Nₘ×Nₒ rounds of expensive model retraining making this approach impractical.

In order to avoid this computationally expensive approach, there is a need for a means of determining influence functions for chains of models.

Combining Influence Functions with Chains of Models

The aim is to work out how much each observed data point influences the synthesis of a synthetic data point. To achieve this, the influence of an observed data point on individual synthesized values within a synthesized data point is calculated. The key factor here is to treat the synthesized values as predictions made by a series of models.

SRMI is able to generate synthesized data points with N+1 features using a chain of N models. Taking the above example, the SRMI model comprises a series of three models (M₁, M₂, M₃) to synthesize the following synthesized feature vector (synthesized-feature-vector-0):

| Sepal-length | Sepal-width | Petal-length | Petal-width |
|---|---|---|---|
| 4.2 | 5.2 | 3.8 | 4.7 |

The first column in the synthesized row is generated by sampling from the corresponding column in the observed data. This selects at random one of the values for that feature from the observed data (sepal length=4.2).

The next column (the second feature) in the synthesized row is generated using a first model M₁ based on the first row (first feature). In the present example, a sepal length of 4.2 results in a sepal width of 5.2.

The influence of each observed data point on this generated synthetic value for sepal width can be calculated. In the present example, this produces the following results:

| | Sepal- | Sepal- | Petal- | Petal- | |
|---|---|---|---|---|---|
| i | length | width | length | width | f_{IF}(xᵢ\|M₁) |
| 1 | 3.2 | 2.9 | 8.1 | 8.7 | 0.5 |
| 2 | 6.4 | 6.2 | 3.2 | 5.1 | 0.72 |
| . . . | . . . | . . . | . . . | . . . | . . . |
| 1000 | 4.1 | 4.9 | 6.1 | 6.7 | 0.87 |

Here, f_{IF}(xᵢ|M₁) denotes the normalized absolute influence function score of each observed data point xᵢ on the prediction of sepal-width=5.2 by model M₁ given sepal-length=4.2. Normalization of the influence functions avoids the influence function for a particular observed feature dominating the combined influence score.

f_{IF} is calculated using the influence function provided above:

$${f}_{IF} ( {x}_{i} \vert {M}_{j} ) = \frac{abs ( influence ( {x}_{i} , {M}_{j} , s ) )}{max} + c$$

where:
s is the synthetic data point under consideration;
max is the maximum value of abs(f_{IF}(x|Mⱼ)) for all x∈observed data points relative to the synthetic data point s under consideration; and
c is a constant (in this case equal to 0.000001).

The constant c is provided to avoid a single influence score of zero taking the whole combined score to zero, as this would not necessarily be indicative of the overall influence across all models. The constant may be set at any appropriate value that avoids an influence score of zero but that does not contribute significantly to the overall influence score.

This approach is repeated to add the influences of the remaining SRMI models M₂, M₃ on the synthesis of the remaining values “petal-length” and “petal-width” respectively:

| | Sepal- | Sepal- | Petal- | Petal- | | | |
|---|---|---|---|---|---|---|---|
| i | length | width | length | width | f_{IF}(xᵢ\|M₁) | f_{IF}(xᵢ\|M₂) | f_{IF}(xᵢ\|M₃) |
| 1 | 3.2 | 2.9 | 8.1 | 8.7 | 0.5 | 0.46 | 0.78 |
| 2 | 6.4 | 6.2 | 3.2 | 5.1 | 0.72 | 0.14 | 0.91 |
| . . . | . . . | . . . | . . . | . . . | . . . | . . . | . . . |
| 1000 | 4.1 | 4.9 | 6.1 | 6.7 | 0.87 | 0.45 | 0.96 |

### Chaining Influence Functions

The embodiments described herein are able to chain together the influence function scores for each synthesized data value in order to calculate the influence of an observed data point on the generation of a synthesized data point (across all of the generated values).

For an observed data point xᵢ, the chained influence function score Score_{IF}(xᵢ) is formed from combining the individual influences on each synthetic data value using the novel formulation below:

$$S c o r {e}_{I F} ( {x}_{i} ) = {\prod }_{i = 1}^{{N}_{m}} {f}_{IF} ( {x}_{i} \vert {M}_{j} )$$

where f_{IF} (xᵢ|Mⱼ) is the normalized influence function score defined above and Nₘ is the total number of models in the synthetic data generation model sequence (i.e. the total number of generated features). In other words, the chained (or combined) influence score is calculated by multiplying together all of the influence function scores across all of the features of the observed data point.

Note that an implementation of Score_{IF} will rely on summing log values to compute the product to avoid potential problems with arithmetic underflow when multiplying a large number of small values.

In the present case this results in the following values for Score_{IF}(xᵢ):

| | Sepal- | Sepal- | Petal- | Petal- | | | | |
|---|---|---|---|---|---|---|---|---|
| i | length | width | length | width | f_{IF}(xᵢ\|M₁) | f_{IF}(xᵢ\|M₂) | f_{IF}(xᵢ\|M₃) | Score_{IF}(xᵢ) |
| 1 | 3.2 | 2.9 | 8.1 | 8.7 | 0.5 | 0.46 | 0.78 | 0.1794 |
| 2 | 6.4 | 6.2 | 3.2 | 5.1 | 0.72 | 0.14 | 0.91 | 0.09178 |
| . . . | . . . | . . . | . . . | . . . | . . . | . . . | . . . | . . . |
| 1000 | 4.1 | 4.9 | 6.1 | 6.7 | 0.87 | 0.45 | 0.96 | 0.37584 |

Score_{IF} can then be employed to rank observed data points in order of influence on the generation of a particular synthetic data point. An inspection the top-ranked observed data points (the data points with the highest combined influence scores) that influenced the synthesis of this point can help to explain why that synthetic data point was generated.

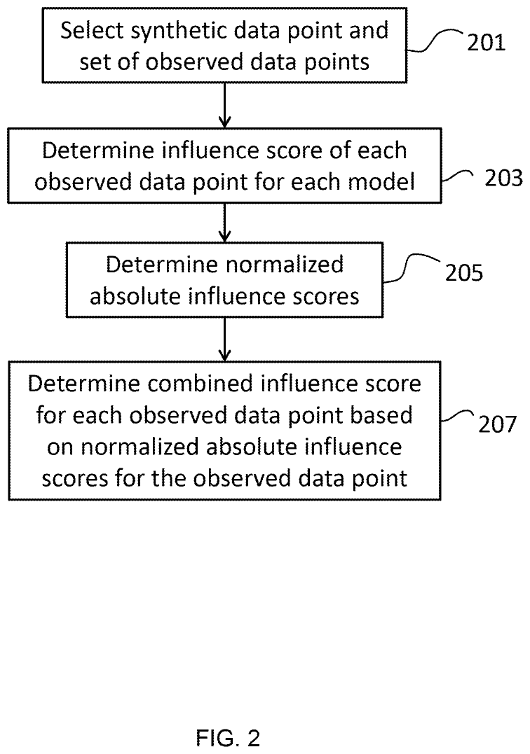

FIG. 2 shows a method of determining a combined influence score of an observed data point on the generation of a synthetic data point according to an embodiment.

The method starts with the selection of a synthetic data point and a set of observed data points for consideration 201. The synthetic data point may have been generated as part of the method, or may have been generated previously, or by an external system, and provided for the purposes of determining influence score(s). As mentioned above, the synthetic data point is generated based on a combination or sequence of machine learning models.

The set of observed data points are the set of observed data points that are considered for the purposes of assessing their influence on the models. This may be the full training set of observed data points that have been used to train the models or may be a subset of the full training set.

The influence score of each observed data point on each model is then determined 203. These influence scores are determined using the influence function described above.

The normalized absolute influence score for each observed data point and for each model is then determined 205.

Finally, the combined influence score for each observed data point is determined 207 based on the normalized absolute influence scores for the corresponding observed data point. As mentioned above, this involves multiplying together the normalized absolute influence scores for the models.

### Establishing Quality of Synthetic Data

Given that the present embodiment is able to establish an estimate for the influence of each observed data point on the synthesis of each synthetic data value and each synthetic data point, this can be complimented by methods to obtain a measure of the overall quality of the synthetic data using the following techniques.

The embodiments described herein provide various quality scores for predictions (e.g. synthesized data) proposed in the present embodiment. A first embodiment makes use of influence scores to calculate a quality metric based on mean reciprocal rank (MRR). A second embodiment makes use of a synthetic data quality metric (termed SYNTHQ) that is based on the notion of distance functions and can be applied to any data synthesis method. Both cases make use of the distance to one or more of the closest observed data points.

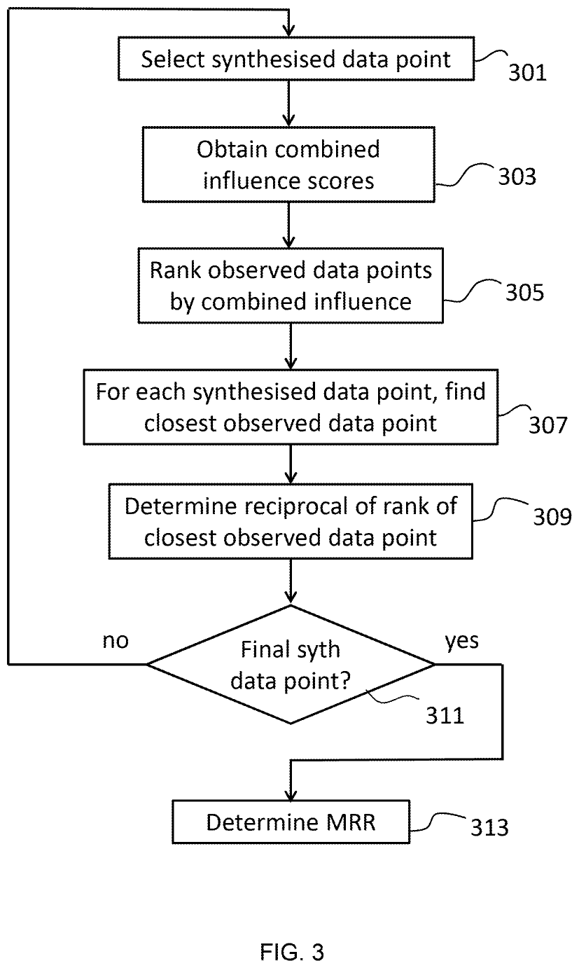

FIG. 3 shows a method of determining a quality metric based on influence scores according to an embodiment.

The method is provided with the set of synthesized points S and the set of observed data points X. The size of S and X should be equal for best results (in terms of the accuracy of the quality score); however, various sizes of S and X might be used.

The method begins by selecting a synthesized data point 301.

The method then obtains the combined influence score on the selected synthesized data point 301 for each of the set of observed data points X. The combined influence scores may either be determined using the method of FIG. 2 or may be accessed from storage (or received from another system) having already been determined.

The method then ranks the observed data points in order of decreasing influence (decreasing order of combined influence score) 305.

f_{INFLUENCE-RANK}(X, S, X) is the rank of observed point x∈X when sorted by descending influence on the synthesis of synthetic data point s. Accordingly, the observed point with a rank of f_{INFLUENCE-RANK}(X, s, x)=1 will be the most influential point, whilst the observed point with the rank off_{INFLUENCE-RANK}(X, s, x)=Nₒ will be the least influential point in the set of observed points X={xᵢ}ᵢ₌₁^{N}^{ₒ}.

For each synthesized data point s∈S, the method finds the closest observed data point to the selected synthesized data point 307. For x∈X the closest observed data point to s is:

$${f}_{C L O S E S T} ( X , s ) = {arg min}_{x ∈ X} Distance ( x , s )$$

where Distance is any suitable distance function computing the distance between two feature vectors (for example, Euclidean distance). The closest observed data point is the data point having the smallest distance to the current synthetic data point.

The method then computes the reciprocal rank of the most similar observed data point (the closest observed data point to the synthesized data point based on the distance metric) 309. This will be the reciprocal of the rank of the closest point in the ranking of observed data points by influence:

$${f}_{RECIPROCAL - RANK ( X , s )} = \frac{1}{{f}_{INFLUENCE - RANK ( X , s , {f}_{CLOSEST ( X , s )} )}}$$

The reciprocal rank of the closest data point provides a quality metric for the synthesized data point. A reciprocal rank of 1 indicates that the closest observed data point to the synthesized data point is also the most influential data point. This suggests that the synthesized data point has been accurately modelled. Conversely, a reciprocal rank of 1/Nₒ means that the closest observed data point to the synthetic data point is the least influential data point in the set of Nₒ observed data points. This suggests that the synthetic data point has been poorly modelled.

The method then determines whether the final synthetic data point in the set of synthetic data points S has been reached 311. That is, the method determines whether the reciprocal rank of the closest observed data point has been determined for every synthetic data point in the set of synthetic data points. If not, then steps 301-309 are repeated, with a different synthesized data point selected.

The above method steps are therefore repeated to calculate the reciprocal rank of the most similar observed data point for each synthesized data point s in the set of synthesized data points S.

Once the reciprocal rank of the most similar observed data point has been calculated for every synthetic data point, the Mean Reciprocal Rank (MRR) for the set of synthesized data points is computed 313. This is determined from the arithmetic mean of the reciprocal ranks computed using the above method over the synthesized data points in the set S:

$$M R R ( X , S ) = \frac{{Σ}_{s ∈ S} {f}_{RECIPROCAL - RANK ( X , s )}}{{N}_{S}}$$

where Nₛ is the number of synthesized data points in S. In other words, the mean reciprocal rank is the harmonic mean of the of the influence scores of the set of closest observed data points.

The value of Mean Reciprocal Rank provides a quality metric for the set of synthesized data points. An MRR of 1.0 indicates a high quality, whilst an MRR of close to 0.0 indicates low quality. The quality is a metric of how accurately the synthesized data points are modelled (how accurately the synthesized data points reflect the attributes of the original distribution of observed data points). A high MRR suggests that the synthesized data accurately mirrors the attributes of the original observed data (accurately reflects the distribution of features across the observed data). This is because a high MRR indicates that the closest observed data point to each synthesized data point is also a very influential data point in the synthesis of that synthesized data point.

Accordingly, MRR based on influence scores allows the user to quantify how well (how accurately) the synthesized data points have been generated. If the quality is low, this suggests that changes need to be made to the models or to the observed data to improve the quality (or suggests that more care should be taken with the use of the synthetic data). Accordingly, the MRR can be used as a metric to control the training of a machine learning system. Where the MRR is low, the system can make a decision to repeat a training step (or take another alternative action) to improve the quality of the predictions being made. This can be repeated until a sufficiently high MRR has been achieved (or a maximum number of iterations have been reached).

In light of the above, the methods described herein provide an efficient and accurate means of assessing the quality of predictions made by chains of machine learning models. This is not only applicable to the generation of synthetic data, but is generally applicable to any machine learning system that makes predictions based on a sequence of machine learning models that have been trained based on observed data points. By introducing a novel means of determining influence scores for sequences of models, the embodiments described herein are more efficient than previous methods that require multiple iterations of retraining in order to determine influence for sequences of models.

In should be noted that, whilst the embodiment of FIG. 3 shows a specific order of steps, some of these steps may be reordered whilst still achieving the function of this embodiment. For instance, step 307 may be moved earlier within the method, for instance ahead of step 305 or step 303. Alternatively, step 307 may be performed in parallel to one or more of steps 303 and 305.

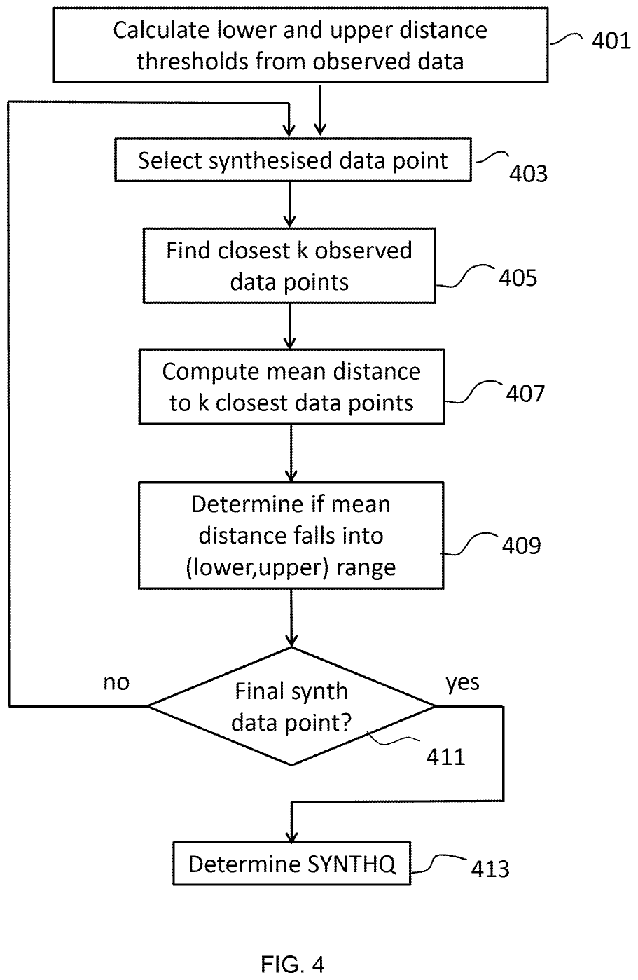

FIG. 4 shows a method of determining the synthetic quality metric SYNTHQ given a set of observed data points and a set of synthetic data points that are synthesized from the observed data points.

This embodiment provides a measure of the quality of the synthetic data by considering the mean distance between synthesized data points and the k closest observed data points, for some suitable value of the neighbourhood size k, for example k=10, and some suitable distance function to compute the distance between a pair of points. If this mean distance is too large, the synthesized point can be thought of as too dissimilar to the observed data points. If this mean distance is too small, the synthesized point can be thought of as too similar to the observed data points. In either case, such synthetic data points can be considered to be of poor quality.

The synthetic quality metric SYNTHQ is the fraction of synthesized data points in the set of synthesized data points that have a mean distance to the closest k observed data points that lies within a predefined range. That is, the synthetic quality metric SYNTHQ is the fraction of synthesized data points in the set of synthesized data points that are located within a predefined range of distances to the mean location of their k closest observed data points. This range is calculated according to the distribution of distances within the set of observed data points.

SYNTHQ returns a value in the range 0.0 to 1.0, where higher values suggest higher quality.

The method begins by calculating an acceptable lower and upper boundary for the mean distance between a synthetic data point and the closest observed data points 401 using the following approach.

The acceptable upper and lower boundaries for the mean distance between a synthetic data point and the closest observed data points can be ascertained using the following functions lower and upper

lower(X,k,L,D)=percentile(L,{∀x∈X:neighbourhood(x,X−{x},k,D)})

upper(X,k,H,D)=percentile(H,{∀x∈X:neighbourhood(x,X−{x},k,D)})

where:
X is the set of observed data points
k is the neighbourhood size, for example 10
L is the low threshold percentage, for example 0.5%, where 0.0% L≤H
H is the high threshold percentage, for example 98.5%, where L<H≤100.0%
D is any function for computing the distance between two points, for example the Euclidean distance function
percentile(i, V) computes the i^{th} percentile of the values in set V where 0.0%≤i≤100.0%
neighbourhood(x, X, k, D) computes the mean distance from point x to each point in the subset of k points in set X that lie closest to x according to distance function D

That is, the boundaries are calculated by calculating, for each observed data point x, the mean distance to the k closest observed data points from X (excluding the observed data point x itself). The lower boundary is the L^{th} percentile of the set of mean distances (the distance at which a first fraction (L %) of observed data points have a smaller mean distance). The upper boundary is the H^{th} percentile of the set of mean distances (the distance at which a second fraction (H %) of observed data points have a smaller mean distance).

The method then selects a synthesized data point s from the set of synthesized data points 403. The method then finds the closest k observed data points to the selected synthesized data point 405.

The mean distance from the synthetic data point s to each of these closest observed data points is calculated 407 using the function neighbourhood(s, X, k, D) in the previous notation.

This mean distance reflects how closely this synthetic data point has been fitted to the observed data. If the distance is too low, then the synthetic data point is overfitted to the observed data points (the model overfits the observed data). This means that the synthetic data point is too similar to the original data and therefore may not even be a synthetic data point (as it might exactly match one or more of the original observed data points). Conversely, if the mean distance is too large then the synthetic data point is an outlier that does not accurately reflect the attributes of the observed data points.

After the mean distance has been calculated, it is then determined whether this mean distance is falls within the range defined by the acceptable lower and upper boundaries 409. This result is recorded.

The method then determines whether the final synthetic data point in the set of synthetic data points has been reached (been analysed) 411. If not, then the method loops back to set 403 to select the next synthetic data point and determine whether it falls within the predefined range of distances.

Accordingly, the method determines, for each synthetic data point, whether the synthetic data point has a distance to the mean location of the k closest observed data points that falls within the predefined range (between the upper and lower boundaries).

Once all synthetic data points have been analysed 411 the SYNTHQ metric can be computed using the formula:

$$SYNTHQ ( S , X , D , k , L , H ) = \frac{{\sum }_{s ∈ S} \{ \begin{matrix}1 & if lower ( X , k , L , D ) \leq \\ & neighbourhood ( s , X , k , D ) \leq upper ( X , k , H , D ) \\ 0 & otherwise\end{matrix}}{\vert S \vert}$$

where:
S is the set of synthesized data points
X is the set of observed data points
D is any function for computing the distance between two points, for example the Euclidean distance function
k is a chosen neighbourhood size, for example 10
L is a chosen low threshold percentage, for example 0.5%, where 0.0%≤L<H
H is a chosen high threshold percentage, for example 98.5%, where L<H≤100.0%
neighbourhood(x, X, k, D) computes the mean distance from point x to each point in the subset of k points in set X that lie closest to x according to distance function D

That is, the synthetic data quality (SYNTHQ) metric is the fraction of synthetic data points that that fall within the predefined range (that has a distance to the mean location of the k closest observed data points that falls within the predefined range).

A set of novel quality metrics is provided that quantify the quality of predications made by a machine learning model. Whilst these embodiments are described above with reference to chains of models for generating synthetic data (for instance, based on the SRMI technique), this is generally applicable to any machine learning methods. The MRR embodiment is applicable for predictions for which influence scores have been calculated. Accordingly, this is applicable not only to the combined influence score described herein but also to influence values calculated using the influence function for a single machine learning model. Equally, the SYNTHQ embodiment is applicable to any machine learning methods. By providing novel and efficient means of quantifying the quality of machine learning predictions, the embodiments described herein allow users to easily determine the quality of the predictions so that remedial action may be taken if the quality is low (for instance, retraining the system). This remedial action can be automated due to the quantitative aspects of the quality values.

### Computing System

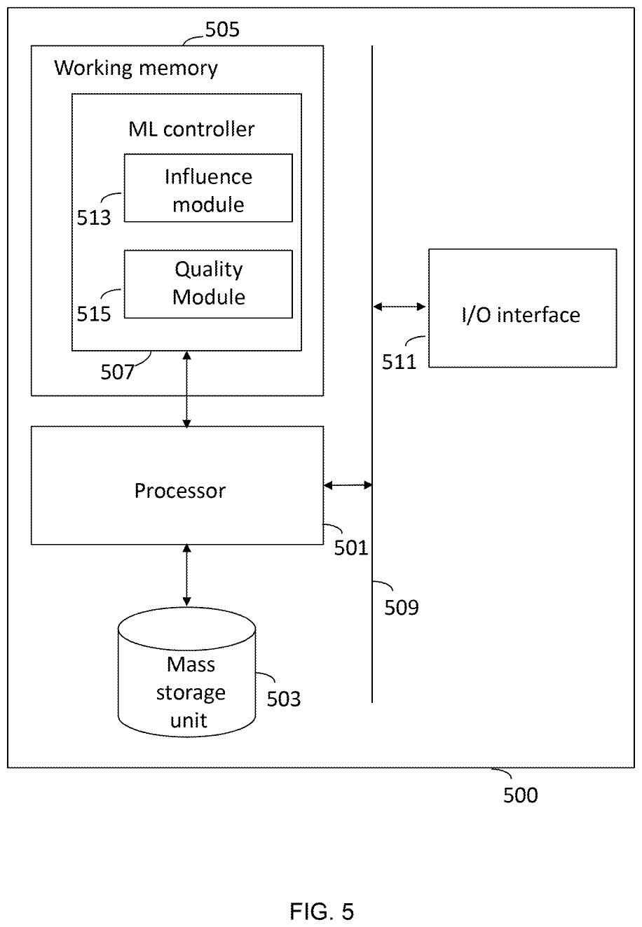

While the reader will appreciate that the above embodiments are applicable to any commuting system for recognising user inputs, a typical computing system is illustrated in FIG. 5, which provides means capable of putting an embodiment, as described herein, into effect. As illustrated, the computing system 500 comprises a processor 501 coupled to a mass storage unit 503 and accessing a working memory 505. As illustrated, a machine learning (ML) controller 507 is represented as a software product stored in working memory 505. However, it will be appreciated that elements of the ML controller 507 may, for convenience, be stored in the mass storage unit 503.

Usual procedures for the loading of software into memory and the storage of data in the mass storage unit 503 apply. The processor 501 also accesses, via bus 509, an input/output interface 511 that is configured to receive data from and output data to an external system (e.g. an external network or a user input or output device). The input/output interface 511 may be a single component or may be divided into a separate input interface and a separate output interface.

The ML controller 507 includes an influence module 513 and a quality module 515. The influence module 513 is configured to determine the influence scores for observed data points relative to predictions (e.g. synthetic data points). The quality module 515 is configured to determine a quality metric representing the quality of the synthetic data. The quality metric might be the synthetic quality (SYNTHQ) metric based on the distances between the observed data points and the predictions (e.g. the synthetic data points). Alternatively, the quality metric might be the mean reciprocal rank (MRR) based on the influence scores of the predictions to provide a quantitative measure of the quality or accuracy of the predictions.

The predictions (e.g. the synthetic data points) may be determined by the ML controller 507 or may be input into the system 500 via the I/O interface 511 along with the details of the model(s) that produced the predictions (e.g. the parameters of the model(s)) for use in determining the influence values.

Thus, execution of the ML software 507 by the processor 501 will cause embodiments as described herein to be implemented.

The ML controller 507 may be configured to determine whether the quality metric is above a threshold and, if not, issue instructions to retrain the model(s). These instructions may cause the ML controller 507 to retrain the model(s) based on adapted settings (e.g. adapted hyperparameters or an adapted observed data set) and generate new predictions using the retrained model(s).

The ML controller 507 may also be configured to output the influence values and/or the quality metric value to the user (via the I/O interface) to provide the user with an indication of the quality of the predictions.

The ML controller software 507 can be embedded in original equipment, or can be provided, as a whole or in part, after manufacture. For instance, the ML controller software 507 can be introduced, as a whole, as a computer program product, which may be in the form of a download, or to be introduced via a computer program storage medium, such as an optical disk. Alternatively, modifications to an existing ML controller 507 can be made by an update, or plug-in, to provide features of the above described embodiment.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for determining an influence of a training data point on a prediction generated according to a machine learning model, the method comprising:
(a) obtaining the training data point, the training data point having an observed value for each of a plurality of features;
(b) obtaining the prediction, the prediction having a predicted value for each of the plurality of features generated according to the machine learning model, the machine learning model comprising a plurality of submodels, wherein each submodel is configured to generate a corresponding predicted value for a corresponding feature of the plurality of features;
(c) for each feature, calculating an influence score representing the influence of the training data point on the prediction of the corresponding predicted value for the feature by the corresponding submodel; and
(d) calculating a combined influence score representing the influence of training data point on the prediction by multiplying together the influence scores for the training data point.

2. The method of claim 1 wherein the influence score for each submodel is based on an influence function conditioned on a loss function for the corresponding submodel and a Hessian matrix of the corresponding submodel.

3. The method of claim 1 wherein one or more of the submodels are conditioned on one or more of the predicted values.

4. The method of claim 1 wherein the influence function is:
influence(xᵢ^{train},M,xⱼ^{test})=−∇ [symbol] (xⱼ^{test},M)=^{T}·H⁻¹·∇ [symbol] (xᵢ^{train},M)
where:
x^{train} is the training data point;
x^{test} is the predicted value determined by submodel M;
∇ [symbol] (x, M) is the gradient of the loss function of submodel M with respect to parameters of the submodel M and evaluated at data point x; and
H is the Hessian matrix of submodel M.

5. The method of claim 1 wherein the training data point is obtained as part of a plurality of training data points that are obtained and the method further comprises repeating step (c) to determine influence scores for one or more further training data points from the plurality of training data points, wherein each of the influence scores is normalized across the plurality of training data points.

6. The method of claim 1 further comprising outputting the combined influence score.

7. The method of claim 1 wherein the training data point is obtained as part of a plurality of training data points that are obtained and the method further comprises:
(e) repeating steps (c)-(d) to determine a corresponding combined influence score for each of the plurality of training data points to form a set of combined influence scores for the prediction.

8. The method of claim 7 further comprising:
(g) determining a quality metric for the prediction, including:
for each of the plurality of training data points, determining a corresponding similarly between the training data point and the prediction in accordance with a similarity metric;
identifying a closest training data point that is the most similar to the prediction in accordance with the similarity metric;
ranking the plurality of training data points in order of combined influence scores to determine a rank for the closest training data point; and
calculating the quality metric for the prediction based on a reciprocal of the rank of the closest training data point.

9. The method of claim 8 wherein the prediction is obtained as part of a plurality of predictions that is obtained, and the method further comprises:
repeating step (f) to determine a corresponding set of combined influence scores for each of the plurality of predictions;
repeating step (g) to determine a quality metric for each of the plurality of predictions; and
determining a combined quality metric for the plurality of predictions based on a mean of the quality metrics for the plurality of predictions.

10. The method of claim 9 further comprising one or more of:
outputting the combined quality metric; and
updating parameters of the machine learning model in response to the combined quality metric being below a predefined threshold.

11. A computer-implemented method for determining one or more quality metrics quantifying the quality of a set of one or more predictions by a machine learning model, the method comprising:
determining a quality metric for each of a set of one or more predictions, including, for each of the set of one or more predictions:
obtaining, for each of a plurality of training data points, an influence score representing the influence of the training data point on the prediction by the machine learning model;
for each of the plurality of training data points, determining a corresponding similarly between the training data point and the prediction in accordance with a similarity metric;
identifying a closest training data point that is the most similar to the prediction in accordance with the similarity metric;
ranking the plurality of training data points in order of influence scores to determine a rank for the closest training data point; and
calculating the quality metric for the prediction based on a reciprocal of the rank of the closest training data point.

12. The method of claim 11 further comprising outputting the quality metric for each of the set of one or more predictions.

13. The method of claim 11 wherein:
the set of one or more predictions comprises a plurality of predictions; and
the method further comprises determining a combined quality metric for the plurality of predictions based on the mean of the quality metrics for the plurality of predictions.

14. The method of claim 13 further comprising outputting the combined quality metric.

15. The method of claim 11 wherein the similarity metric is a distance metric.

16. The method of claim 11 wherein:
each training data point has an observed value for each of a plurality of features;
each prediction has a predicted value for each of the plurality of features generated according to the machine learning model, wherein the machine learning model comprises a plurality of submodels, wherein each submodel is configured to generate a corresponding predicted value for a corresponding feature of the plurality of features; and
obtaining, for each of a plurality of training data points, an influence score representing the influence of the training data point on the prediction by the machine learning model comprises:
for each feature, calculating a submodel influence score representing the influence of the training data point on the prediction of the corresponding predicted value for the feature by the corresponding submodel; and
calculating the influence score representing the influence of training data point on the prediction by multiplying together the submodel influence scores for the training data point.

17. A computer-implemented method for determining a quality metric quantifying the quality of a set of one or more synthetic data points generated by a machine learning model, the method comprising:
obtaining a set of training data points and a set of one or more synthetic data points generated based on a machine learning model that has been trained using the set of training data points;
determining a set of one or more mean distances by, for each of the set of one or more synthetic data points:
identifying the k closest training data points to the synthetic data point from the set of training data points based on a distance metric, wherein k is a predefined number; and
determining the mean distance from the synthetic data point to the k closest training data points; and
outputting a quality metric based on the set of one or more mean distances.

18. The method of claim 17 wherein the set of one or more synthetic data points comprises a plurality of synthetic data points and the method further comprises determining the quality metric as an indicator of the quality of the plurality of synthetic data points including determining the fraction of the plurality of synthetic data points that have a mean distance that falls within a range.

19. The method of claim 18 wherein the method further comprises:
determining a further set of mean distances by, for each training data point:
identifying the k closest training data points to the training data point based on the distance metric; and
determining the mean distance from the training data point to the k closest training data points; and
determining the range based on the further set of mean distances.

20. The method of claim 19 wherein determining the range comprises determining an upper threshold for the range, wherein a first predefined proportion of the training data points have mean distances that are less than the upper threshold.

21. The method of claim 20 wherein determining the range comprises determining a lower threshold for the range, wherein a second predefined proportion of the training data points have mean distances that are less than the upper threshold, the second predefined proportion being smaller than the first predefined portion.

22. A computing system comprising one or more processors configured to perform the method of claim 1.

23. A computing system comprising one or more processors configured to perform the method of claim 11.

24. A computing system comprising one or more processors configured to perform the method of claim 17.

25. A non-transitory computer readable medium comprising instructions that, when executed by one or more processors, cause the one or more processors to perform the method of claim 1.

26. A non-transitory computer readable medium comprising instructions that, when executed by one or more processors, cause the one or more processors to perform the method of claim 11.

27. A non-transitory computer readable medium comprising instructions that, when executed by one or more processors, cause the one or more processors to perform the method of claim 17.
